(19) United States
(12) Patent Application Publication
(10) Pub. No.: US 2026/0243247 A1
(43) Pub. Date: Aug. 20, 2026

(54) PUMP SYSTEM

(71) Applicant: KAWASAKI JUKOGYO KABUSHIKI KAISHA, Kobe-shi, Hyogo (JP)

(72) Inventors: Kazuya IWABE, Kobe-shi (JP); Yusuke OKIMURA, Kobe-shi (JP); Yoji YUDATE, Kobe-shi (JP); Hiroki OHSHIMA, Kobe-shi (JP)

(21) Appl. No.: 19/474,622

(22) PCT Filed: Nov. 28, 2023
(86) PCT No.: PCT/JP2023/042600

§ 371 Date: Oct. 10, 2025

(30) Foreign Application Priority Data
Apr. 18, 2023 (JP) 2023-067986

(51) Int. Cl. F04B 49/12; F15B 1/26; F15B 13/02; F15B 15/18

(52) U.S. Cl. CPC F04B 49/12; F15B 1/26; F15B 13/022; F15B 15/18

(57) ABSTRACT

A pump system includes: a variable capacity hydraulic pump; a regulator; a control valve; a first pressure sensor upstream of the control valve; a second pressure sensor downstream of the control valve; and a control device that controls the discharge capacity of the hydraulic pump. By changing a command signal output to the regulator, under a measurement condition in which the opening degree control valve is fixed at a predetermined opening degree, the control device causes the pressure sensors to detect upstream pressure and downstream pressures with a plurality of different command signals, calculates, for each command signal, an actual discharge flow rate of the working fluid discharged from the hydraulic pump, from the opening degree and the upstream-downstream pressure difference of the control valve, and creates a correction table from the command discharge flow rate and the actual discharge flow rate with respect to each command signal.

### TECHNICAL FIELD

The present disclosure relates to a pump system that creates a correction table for correcting a command discharge flow rate at a hydraulic pump of the variable capacity type.

### BACKGROUND ART

In hydraulic pumps of the variable capacity type, a current command value is output according to the pump characteristics indicating the relationship between a command discharge flow rate and a current command value (i.e., the I-Q characteristics), and thus a working fluid is discharged at a command discharge flow rate. Meanwhile, in the case of hydraulic pumps, the flow rate of the working fluid discharged with respect to the current command value varies from pump to pump. Therefore, in hydraulic pumps, the pump characteristics are calibrated so that the working fluid is discharged at a command discharge flow rate with respect to a current command value. As a system that calibrates the pump characteristics, a calibration system such as that disclosed in Patent Literature (PTL) 1 is known, for example.

### CITATION LIST

### Patent Literature

PTL 1: Japanese Laid-Open Patent Application Publication No. 2019-190443

### SUMMARY OF INVENTION

### Technical Problem

The calibration system disclosed in PTL 1 measures pump pressure with respect to each current command value while changing the current command value in multiple stages, and calibrates a pump control table, i.e., the pump characteristics, on the basis of the measured pump pressure and the specified pump flow rate with respect to a reference command value. Therefore, with the calibration system disclosed in PTL 1, the pump flow rates can be calibrated with respect to various current command values. However, in the calibration system disclosed in PTL 1, in which the pump characteristics are calibrated on the basis of the specified pump flow rates, a difference occurs between the actual pump flow rate and the command discharge flow rate when the pump flow rate varies from pump to pump. It is desirable to minimize the difference between the command discharge flow rate and the actual pump flow rate.

Thus, an object of the present disclosure is to provide a pump system in which the difference between a command discharge flow rate and an actual pump flow rate can be minimized.

### Solution to Problem

A pump system according to the first disclosure includes: a hydraulic pump of a variable capacity type having a discharge capacity that is changeable; a regulator that changes the discharge capacity of the hydraulic pump according to a command signal that is input to the regulator; an opening degree control valve connected to the hydraulic pump and having an opening degree that is changeable; a first pressure sensor that measures upstream pressure that is hydraulic pressure of a working fluid flowing from the hydraulic pump to the opening degree control valve; a second pressure sensor that measures downstream pressure that is hydraulic pressure of the working fluid flowing from the opening degree control valve; and a control device that controls the discharge capacity of the hydraulic pump according to pump characteristics indicating a relationship between a command discharge flow rate and the command signal. By changing the command signal to be output to the regulator, under a measurement condition in which the opening degree of the opening degree control valve is fixed at a predetermined opening degree, the control device causes the first pressure sensor and the second pressure sensor to detect the upstream pressure and the downstream pressure, respectively, with a plurality of command signals different from each other, calculates, for each command signal, an actual discharge flow rate of the working fluid discharged from the hydraulic pump, on the basis of the opening degree of the opening degree control valve and a pressure difference between pressure on an upstream side of the opening degree control valve and pressure on a downstream side of the opening degree control valve that is calculated on the basis of the upstream pressure and the downstream pressure detected, and creates a correction table for correcting the command discharge flow rate on the basis of the command discharge flow rate and the actual discharge flow rate with respect to each command signal.

According to the first disclosure, the actual discharge flow rate is calculated for each command signal on the basis of the pressure difference and the opening degree of the opening degree control valve. Subsequently, the correction table is created on the basis of the command discharge flow rate and the actual discharge flow rate with respect to each command signal. Therefore, the control device outputs the command signal according to the command discharge flow rate corrected using the correction table, allowing the working fluid to be actually discharged from the hydraulic pump at a flow rate corresponding to the command discharge flow rate. Thus, it is possible to minimize the difference between the command discharge flow rate and the actual pump flow rate.

A pump system according to the second disclosure includes: a hydraulic pump of a variable capacity type having a discharge capacity that is changeable; a regulator that changes the discharge capacity of the hydraulic pump according to a command signal that is input to the regulator; an unloader valve disposed between the hydraulic pump and a tank and having an opening degree that is changeable; a first pressure sensor that measures hydraulic pressure of a working fluid flowing from the hydraulic pump to the unloader valve; and a control device that controls the discharge capacity of the hydraulic pump according to pump characteristics indicating a relationship between a command discharge flow rate and the command signal. By changing the command signal to be output to the regulator, under a measurement condition in which the opening degree of the unloader valve is fixed at a predetermined opening degree, the control device causes the first pressure sensor to detect the hydraulic pressure, with a plurality of command signals different from each other, calculates, for each command signal, an actual discharge flow rate of the working fluid discharged from the hydraulic pump, on the basis of the opening degree of the unloader valve and a pressure difference between pressure on an upstream side of the unloader valve and pressure on a downstream side of the unloader valve that is calculated on the basis of the hydraulic pressure detected, and creates a correction table for correcting the command discharge flow rate on the basis of the command discharge flow rate and the actual discharge flow rate with respect to each command signal.

According to the second disclosure, the actual discharge flow rate is calculated for each command signal on the basis of the pressure difference and the opening degree of the unloader valve. Subsequently, the correction table is created on the basis of the command discharge flow rate and the actual discharge flow rate with respect to each signal value. Therefore, the control device allows the working fluid to be actually discharged from the hydraulic pump at a flow rate corresponding to the command discharge flow rate. Thus, it is possible to minimize the difference between the command discharge flow rate and the actual pump flow rate.

### Advantageous Effects of Invention

According to the first and second disclosures, it is possible to minimize the difference between the command discharge flow rate and the actual pump flow rate.

The above object, other objects, features, and advantages of the present disclosure will be made clear by the following detailed explanation of preferred embodiments with reference to the attached drawings.

### BRIEF DESCRIPTION OF DRAWINGS

FIG. 1 is a circuit diagram illustrating a hydraulic drive system including a pump system according to Embodiment 1.

FIG. 2 is a flowchart illustrating the procedures in a discharge flow rate control and a correction table creation method performed by the control device of FIG. 1.

FIG. 3 is a graph showing the pump characteristics to be calibrated by the pump system of FIG. 1.

FIG. 4 is a circuit diagram illustrating a hydraulic drive system including a pump system according to Embodiment 2.

FIG. 5 is a graph showing the pump characteristics to be calibrated by the pump system of FIG. 4.

FIG. 6 is a circuit diagram illustrating a hydraulic drive system including a pump system according to Embodiment 3.

FIG. 7 is a circuit diagram illustrating a hydraulic drive system including a pump system according to Embodiment 4.

### DESCRIPTION OF EMBODIMENTS

Hereinafter, pump systems 1 and 1A to 1C according to Embodiments 1 to 4 of the present disclosure will be described with reference to the aforementioned drawings. Note that the concept of directions mentioned in the following description is used for the sake of explanation; the orientations, etc., of elements according to the present disclosure are not limited to these directions. Each of the pump systems 1 and 1A to 1C described below is merely one embodiment of the present disclosure. Thus, the present disclosure is not limited to the embodiments and may be subject to addition, deletion, and alteration within the scope of the essence of the present disclosure.

### Embodiment 1

### <Pump System>

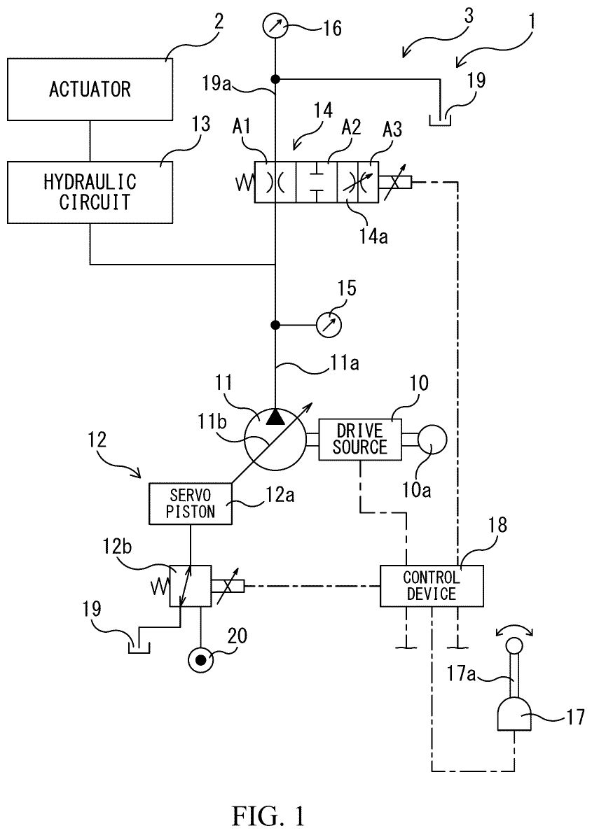

The pump system 1 illustrated in FIG. 1 is included, for example, in hydraulic equipment (not illustrated in the drawings). Examples of the hydraulic equipment include work vehicles that are construction vehicles such as a hydraulic excavator and a hydraulic crane and industrial vehicles such as a forklift. Note that the hydraulic equipment is not limited to a work vehicle and may be farm equipment, a ship or boat, hydrogen-related equipment, medical equipment, or the like. The hydraulic equipment includes at least one actuator 2 and a hydraulic drive system 3 including the pump system 1. Examples of the actuator 2 include a hydraulic cylinder and a hydraulic motor. In a hydraulic excavator, for example, the actuator 2 is a boom cylinder, an arm cylinder, a bucket cylinder, a slewing motor, a travel motor, and the like. The hydraulic drive system 3 supplies a working fluid (for example, working oil) to the actuator 2 and drains the working fluid from the actuator 2. This actuates the actuator 2, allowing the hydraulic equipment to perform various tasks. The hydraulic drive system 3 including such functions includes a hydraulic pump 11, a regulator 12, a hydraulic circuit 13, an unloader valve 14, two pressure sensors 15, 16, an operation device 17, and a control device 18. The pump calibration system 1 is configured to include at least the hydraulic pump 11, the regulator 12, the unloader valve 14, the two pressure sensors 15, 16, and the control device 18.

The hydraulic pump 11 is driven to rotate by a drive source (for example, an engine or an electric motor) 10. By being driven to rotate, the hydraulic pump 11 discharges the working fluid to a pump passage 11a. The hydraulic pump 11 is a pump of the variable capacity type. In the present embodiment, the hydraulic pump 11 is a swash plate pump of the variable capacity type and changes the discharge capacity thereof by tilting a swash plate 11b. Note that the hydraulic pump 11 may be an axial piston pump of the variable capacity type; it is sufficient that the hydraulic pump 11 be a pump with a variable discharge capacity that is capable of discharging the working fluid.

The regulator 12 changes the discharge capacity of the hydraulic pump 11 according to a command signal (more specifically, the signal value of the command signal) that is input to the regulator 12. Note that the command signal is a current signal in the present embodiment. Note that the command signal is not limited to the current signal and may be a voltage signal or a controller area network (CAN) signal. The regulator 12 includes a servo piston 12a and an electromagnetic proportional valve 12b, for example. The servo piston 12a is connected to the swash plate 11b. The servo piston 12a moves to a position corresponding to pilot pressure that is input to the servo piston 12a. The movement of the servo piston 12a causes tilting of the swash plate 11b. As a result, the tilt angle of the swash plate 11b changes, and the discharge capacity of the hydraulic pump 11 is adjusted to a level of capacity corresponding to the tilt angle, that is, a level of capacity corresponding to the input pilot pressure.

The electromagnetic proportional valve 12b outputs pilot pressure corresponding to the command signal. More specifically, the electromagnetic proportional valve 12b is connected to a pilot pump 20, a tank 19, and the regulator 12, for example. By adjusting the opening degree of a passage leading to each of the pilot pump 20 and the tank 19, the electromagnetic proportional valve 12b outputs the pilot pressure corresponding to the command signal to the servo piston 12a. The servo piston 12a moves to a position corresponding to the pilot pressure. Thus, the discharge capacity of the hydraulic pump 11 changes. In other words, the regulator 12 changes the discharge capacity of the hydraulic pump 11 according to the command signal. Note that the electromagnetic proportional valve 12b is not limited to that described thus far as long as the electromagnetic proportional valve 12b can output the pilot pressure corresponding to the command signal.

The hydraulic circuit 13 is connected to each of the hydraulic pump 11 and at least one actuator 2. More specifically, the hydraulic circuit 13 is connected to the hydraulic pump 11 via the pump passage 11a. Furthermore, the hydraulic circuit 13 brings, to the actuator 2, the working fluid discharged from the hydraulic pump 11. The hydraulic circuit 13 controls the flow of the working fluid that flows from the hydraulic pump 11 to the actuator 2. The hydraulic circuit 13, which includes various valves such as a relief valve and a control valve, for example, actuates the various valves, thereby controlling the flow of the working fluid.

The unloader valve 14, which is an example of the opening degree control valve, is disposed between the hydraulic pump 11 and the tank 19. The unloader valve 14 can change the opening degree between the hydraulic pump 11 and the tank 19 (hereinafter, referred to as “the opening degree of the unloader valve 14”). More specifically, the unloader valve 14 is connected on the upstream side of the hydraulic circuit 13 in the pump passage 11a. Note that the unloader valve 14 may be connected on the downstream side of the hydraulic circuit 13 in the pump passage 11a. The unloader valve 14 allows the working fluid discharged from the hydraulic pump 11 to be drained to the tank 19, thereby placing the hydraulic pump 11 in the unloaded state. In the present embodiment, the unloader valve 14 is a three-position spool valve. Specifically, the unloader valve 14 includes a spool 14a which is a valve body. The spool 14a moves to one of the first to third positions A1 to A3 according to a position signal that is input thereto. The spool 14a at the first position A1, which is a neutral position, fixes the opening degree of the unloader valve 14 at a first opening degree. The spool 14a at the second position blocks the path between the hydraulic pump 11 and the tank 19. Furthermore, the spool 14a at the third position A3 changes the opening degree of the unloader valve 14 according to a stroke length. Note that the unloader valve 14 is not limited to a three-position spool valve, but may be a two-position spool valve or may be a four or more position spool valve.

The first pressure sensor 15 measures upstream pressure (for example, the discharge pressure of the hydraulic pump 11), which is the hydraulic pressure of the working fluid flowing from the hydraulic pump 11 to the unloader valve 14. In the present embodiment, the first pressure sensor 15 is connected to the pump passage 11a. More specifically, the first pressure sensor 15 is connected on the upstream side of the unloader valve 14 in the pump passage 11a. The first pressure sensor 15 measures, as the upstream pressure, the pressure of the working fluid flowing through the pump passage 11a.

The second pressure sensor 16 measures downstream pressure (that is tank pressure in the present embodiment), which is the hydraulic pressure of the working fluid flowing from the unloader valve 14. More specifically, the second pressure sensor 16 is connected to a tank passage 19a. The tank passage 19a is a passage that connects the unloader valve 14 and the tank 19. The second pressure sensor 16 measures, as the downstream pressure, the pressure of the working fluid flowing through the tank passage 19a, that is, the tank pressure.

The operation device 17 is a device for operating the actuator 2. The operation device 17 includes at least one operation lever 17a, which is an operation tool, for example. The operation device 17 outputs an operation command corresponding to the amount of tilt (the operation amount) of the operation lever 17a. In the present embodiment, the operation device 17 is an electric joystick, for example. Note that the operation device 17 may be an operation valve including the operation lever 17a. In this case, the operation device 17 detects, using a pressure sensor (not illustrated in the drawings), pilot pressure that is output from the operation valve, and outputs the command signal corresponding to the detected pilot pressure. The operation tool may be an operation pedal; the form of the operation tool is not limited as long as the operation tool outputs the operation command corresponding to the operation amount.

The control device 18 obtains the discharge pressure of the hydraulic pump 11 (that is, the upstream pressure of the unloader valve 14) from the first pressure sensor 15, and obtains the tank pressure (that is, the upstream pressure of the unloader valve 14) from the second pressure sensor 16. Furthermore, the control device 18 controls the drive source 10, the regulator 12, the hydraulic circuit 13, and the unloader valve 14 according to the command signal from the operation device 17.

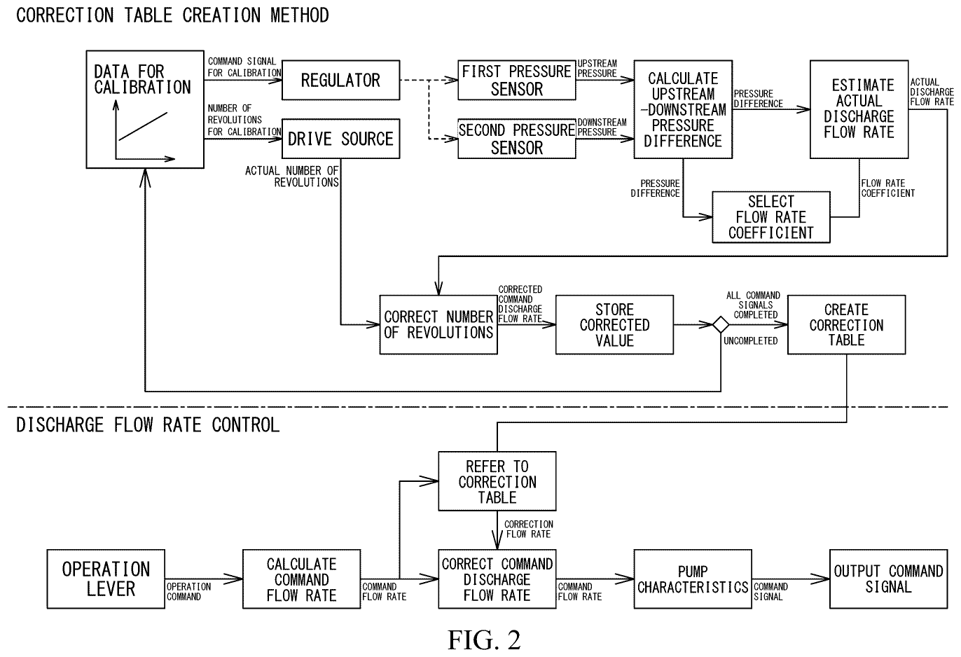

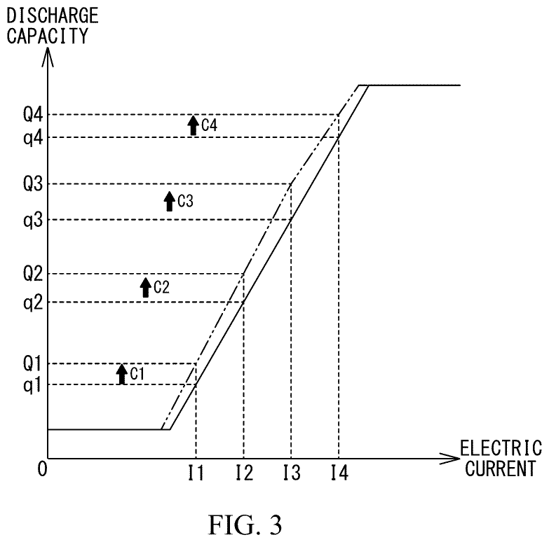

More specifically, the control device 18 controls the regulator 12 as illustrated in the flowchart of the discharge capacity control in FIG. 2. Specifically, when the operation device 17 is operated, the operation command is input from the operation device 17 to the control device 18. Accordingly, the control device 18 calculates a command discharge flow rate which is the flow rate of the working fluid to be discharged from the hydraulic pump 11 according to the operation command. Subsequently, the control device 18 calculates a correction flow rate on the basis of the correction table to be described later and the command discharge flow rate. Furthermore, the control device 18 corrects the command discharge flow rate on the basis of the correction flow rate. Moreover, on the basis of the pump characteristics shown in FIG. 3 and the corrected command discharge flow rate, the control device 18 calculates the command signal to be provided to the regulator 12. Subsequently, the control device 18 outputs the command signal to the regulator 12 and thus controls the regulator 12, in other words, controls the discharge capacity of the hydraulic pump 11. Note that the pump characteristics are a function (or a table) representing the relationship between the command signal and the command discharge flow rate. In the present embodiment, the pump characteristics obtained by preceding measurement or the like are stored in the control device 18 in advance. More specifically, the pump characteristics are set by measurement performed during rotation of the hydraulic pump 11 at a basic number of revolutions that is a predetermined number of revolutions.

Furthermore, the control device 18 outputs the position signal to the unloader valve 14. Accordingly, the position and the stroke length of the spool 14a are controlled. Thus, the amount of the working fluid to be drained from the hydraulic pump 11 to the tank 19 is controlled, and the control device 18 outputs the control command to the hydraulic circuit 13. Accordingly, the flow of the working fluid flowing from the hydraulic pump 11 to the actuator 2 is controlled. Moreover, the control device 18 controls the drive source 10. Thus, the speed of rotation of the hydraulic pump 11 is adjusted.

Furthermore, the control device 18 constitutes the pump system 1 together with the hydraulic pump 11, the regulator 12, the unloader valve 14, and the two pressure sensors 15, 16 as mentioned above. Together with these elements, the control device 18 can create a correction table. Specifically, the control device 18 creates a correction table by performing a correction table creation method to be described in detail later. The correction table is a table showing a correction flow rate to be applied for correction to (for example, to be added to or subtracted from) each command discharge flow rate. In the present embodiment, the correction flow rate is the difference between the command discharge flow rate and the actual discharge flow rate. The actual discharge flow rate is the flow rate of the working fluid actually discharged from the hydraulic pump 11 when the command signal is output to the regulator 12 in the hydraulic drive system 3.

Note that the control device 18 includes memory and a processor that are not illustrated in the drawings. The memory stores the detection results of the two pressure sensors 15, 16. Furthermore, the memory not only stores the pump characteristics and the correction table described above, but also stores various programs so that the operations of the regulator 12, the hydraulic circuit 13, and the unloader valve 14 are controlled and the correction table creation method is performed, for example. The processor performs the programs stored in the memory to actuate the regulator 12, the hydraulic circuit 13, and the unloader valve 14 and perform the correction table creation method.

### <Correction Table Creation Method>

In the pump system 1, the control device 18 performs the correction table creation method, and thus the correction table is created. Subsequently, using the correction table created by the correction table creation method, the control device 18 corrects the command discharge flow rate, thereby allowing the working fluid to be discharged from the hydraulic pump 11 at a desired flow rate. Next, the correction table creation method will be described.

When the correction table creation method is performed, the control device 18 changes the command signal (specifically, changes the signal value of the command signal) to be output to the regulator 12 under a measurement condition. Thus, with a plurality of command signals different from each other, the control device 18 causes the first pressure sensor 15 and the second pressure sensor 16 to detect the upstream pressure and the downstream pressure, respectively. The measurement condition includes the opening degree of the unloader valve 14 being fixed at the first opening degree. In the present embodiment, the measurement condition further includes the number of revolutions of the hydraulic pump 11 being the number of revolutions for calibration that is set in advance for each command signal. Therefore, by controlling the drive source 10, the control device 18 adjusts the number of revolutions of the hydraulic pump 11 to the number of revolutions for calibration that corresponds to the command signal. Note that the number of revolutions for calibration is set to decrease as the tilt angle increases and is set to increase as the tilt angle decreases, for example. Thus, the working fluid can be discharged from the hydraulic pump 11 at an appropriate flow rate during calibration.

Next, the control device 18 calculates the upstream-downstream pressure difference of the unloader valve 14 on the basis of the upstream pressure and the downstream pressure. The upstream-downstream pressure difference is the difference in pressure between the upstream side and the downstream side of the unloader valve 14. On the basis of the upstream-downstream pressure difference and the opening degree of the unloader valve 14, the control device 18 calculates, for each command signal, the discharge flow rate of the working fluid that is actually discharged from the hydraulic pump 11, namely, an actual discharge flow rate. Subsequently, the control device 18 creates a correction table on the basis of the command discharge flow rate and the actual discharge flow rate with respect to each command signal.

With reference to the flowchart in FIG. 2, the correction table creation method will be described below in more detail. In the pump system 1, a plurality of command signals different from each other (hereinafter referred to as “command signals for calibration”) are stored in the control device 18 in order to create a correction table. Furthermore, in the pump system 1, a plurality of command signals for calibration (for example, refer to the command signals I1 to I4 in FIG. 3) are output and the upstream pressure and the downstream pressure are detected under the measurement condition. During this period, the spool 14a of the unloader valve 14 is held at the first position A1. Thus, the opening degree of the unloader valve 14 is fixed at the first opening degree.

Furthermore, in the present embodiment, the measurement condition includes the number of revolutions of the hydraulic pump 11 being the number of revolutions that is set in advance for each command signal. Therefore, a table of the number of revolutions for calibration showing the relationship between the command signal for calibration and the rotational speed (that is the number of revolutions in the present embodiment) of the hydraulic pump 11 is stored in the control device 18. The control device 18 outputs a command of the number of revolutions to the drive source 10 on the basis of the command signal for calibration to be output and the table of the number of revolutions for calibration. Accordingly, the drive source 10 is controlled, and the number of revolutions of the hydraulic pump 11 is adjusted to the number of revolutions that corresponds to the command signal for calibration. Furthermore, in the present embodiment, the measurement condition includes the control valves (not illustrated in the drawings) in the hydraulic circuit 13 being closed in order that the entire working fluid discharged from the hydraulic pump 11 flows through the unloader valve 14. Therefore, the control device 18 controls the control valves (not illustrated in the drawings) in the hydraulic circuit 13 in order to satisfy the measurement condition.

When the entire measurement condition is satisfied, the control device 18 outputs one of the command signals for calibration to the regulator 12 under the measurement condition. Accordingly, the discharge capacity of the hydraulic pump 11 is controlled and set to a capacity corresponding to the command signal for calibration. Subsequently, the working fluid is discharged from the hydraulic pump 11. The control device 18 then calculates the upstream-downstream pressure difference of the unloader valve 14 on the basis of the upstream pressure and the downstream pressure detected by the two pressure sensors 15, 16. Furthermore, on the basis of the upstream-downstream pressure difference and the first opening degree of the unloader valve 14, the control device 18 then calculates the flow rate of the working fluid flowing through the unloader valve 14 (that is, the actual discharge flow rate at the hydraulic pump 11). In calculating the actual discharge flow rate at the hydraulic pump 11, a flow rate coefficient α is used in the present embodiment; for example, the control device 18 estimates an actual discharge flow rate Q at the hydraulic pump 11 on the basis of Equation (1) indicated blow.

$$[ Math . 1 ]$$

$$Q = α A \sqrt{Δ P} \qquad ( 1 )$$

In this equation, Q is the actual discharge flow rate, A is the opening area of the unloader valve 14, ΔP is the upstream-downstream pressure difference of the unloader valve 14, and the flow rate coefficient α is set by the control device 18 according to the state of the upstream-downstream pressure difference ΔP. More specifically, in the control device 18, a flow rate coefficient table is stored that shows the relationship between the flow rate coefficient α and not only the upstream-downstream pressure difference ΔP of the unloader valve 14, but also the opening area of the unloader valve 14. The control device 18 determines the flow rate coefficient α on the basis of the upstream-downstream pressure difference ΔP and the flow rate coefficient table. Note that the flow rate coefficient table is a table configured by preceding measurement (for example, measurement at the time of manufacture) and has been stored in the control device 18 in advance.

Furthermore, the control device 18 calculates a corrected discharge flow rate by correcting the estimated actual discharge flow rate using the number of revolutions (the corrected discharge flow rates Q1 to Q4 in FIG. 3). Specifically, the control device 18 calculates a corrected discharge flow rate that is a converted flow rate at which the working fluid is discharged during rotation of the hydraulic pump 11 at the basic number of revolutions. More specifically, the control device 18 divides the actual discharge flow rate by the actual number of revolutions of the drive source 10 and multiplies the result with the basic number of revolutions. Note that a rotational speed sensor 10a is provided on the drive source 10. The control device 18 obtains the actual number of revolutions using the rotational speed sensor 10a. The basic number of revolutions is a predetermined number of revolutions that is set to measure the default pump characteristics as mentioned above.

Furthermore, when the control device 18 calculates the corrected discharge flow rate, the control device 18 calculates a command discharge flow rate with respect to the command signal for calibration that has been output on the basis of the pump characteristics (the command discharge flow rates q1 to q4 in FIG. 3). Subsequently, the control device 18 calculates a correction flow rate which is the difference between the command discharge flow rate and the corrected discharge flow rate (refer to the correction flow rates C1 to C4 in FIG. 3). Moreover, the control device 18 stores the command discharge flow rate and the correction flow rate in association.

The control device 18 repeats calculating and storing a correction flow rate for a command signal for calibration until correction flow rates are calculated for all the command signals for calibration and corrected discharge flow rates are stored in association. When correction flow rates are calculated and stored in association with all the command signals for calibration, the control device 18 creates a correction table on the basis of the relationship between the command discharge flow rates and the correction flow rates stored. More specifically, on the basis of command discharge flow rates and correction flow rates stored in association with the command discharge flow rates, the control device 18 creates a correction table showing a correction flow rate (refer to the correction flow rates C1 to C4 in FIG. 3) with respect to a command discharge flow rate (refer to the command discharge flow rates q1 to q4 in FIG. 3).

Using the correction table, the control device 18 controls the regulator 12 as follows. Specifically, when the control device 18 receives an operation command from the operation device 17, the control device 18 calculates a command discharge flow rate on the basis of the operation command, as illustrated in FIG. 2. Furthermore, the control device 18 corrects the command discharge flow rate on the basis of the correction table. More specifically, the control device 18 calculates a correction flow rate on the basis of the command discharge flow rate and the correction table. Furthermore, the control device 18 corrects the command discharge flow rate on the basis of the correction flow rate. For example, the control device 18 subtracts the correction flow rate from the command discharge flow rate (or adds the correction flow rate to the command discharge flow rate). Thereafter, on the basis of the corrected command discharge flow rate and the pump characteristics, the control device 18 calculates the command signal to be output to the regulator 12. Subsequently, the control device 18 outputs the command signal to the regulator 12. Thus, in the pump system 1, the working fluid can be discharged from the hydraulic pump 11 at a flow rate corresponding to the command discharge flow rate.

In the pump system 1 according to the present embodiment, the actual discharge flow rate is calculated for each command signal on the basis of the upstream-downstream pressure difference and the opening degree of the unloader valve 14. Subsequently, the correction table is created on the basis of the command discharge flow rate and the actual discharge flow rate with respect to each command signal. Therefore, the control device 18 outputs the command signal according to the command discharge flow rate corrected using the correction table, allowing the working fluid to be actually discharged from the hydraulic pump 11 at a flow rate corresponding to the command discharge flow rate. Thus, it is possible to minimize the difference between the command discharge flow rate and the actual pump flow rate.

Furthermore, in the pump system 1 according to the present embodiment, the flow rate coefficient α is set in the control device 18 according to the state of the upstream-downstream pressure difference. Therefore, the actual discharge flow rate can be calculated with increased accuracy. Thus, it is possible to further minimize the difference between the command discharge flow rate and the actual pump flow rate.

Furthermore, in the pump system 1 according to the present embodiment, the control device 18 creates the correction table on the basis of the difference between the command discharge flow rate and the actual discharge flow rate with respect to each command signal. Therefore, it is possible to further minimize the difference between the command discharge flow rate and the actual pump flow rate.

Furthermore, in the pump system 1 according to the present embodiment, the measurement condition includes the number of revolutions of the hydraulic pump 11 being the number of revolutions that is set in advance for each command signal. By maintaining the number of revolutions at a predetermined number of revolutions, the flow rate of the working fluid discharged from the hydraulic pump 11 can be prevented from varying due to fluctuations in the number of revolutions. As a result, variations in the discharge pressure at the hydraulic pump 11 can be reduced and thus, the actual discharge flow rate can be calculated with increased accuracy. Thus, it is possible to further minimize the difference between the command discharge flow rate and the actual pump flow rate.

Furthermore, in the pump system 1 according to the present embodiment, the control device 18 holds the spool 14a of the unloader valve 14 at the first position A1 in order to satisfy the first measurement condition. Therefore, the opening degree of the unloader valve 14 can be easily maintained at the first opening degree. As a result, the actual discharge flow rate can be calculated with increased accuracy. Thus, it is possible to further minimize the difference between the command discharge flow rate and the actual pump flow rate.

Furthermore, in the pump system 1 according to the present embodiment, the unloader valve 14 is connected to the pump passage 11a on the upstream side of the hydraulic circuit 13. Therefore, pressure loss that occurs in the working fluid flowing from the hydraulic pump 11 to the unloader valve 14 has less impact, enabling accurate calculation of the upstream-downstream pressure difference of the unloader valve 14. As a result, the actual discharge flow rate can be calculated with increased accuracy. Thus, it is possible to further minimize the difference between the command discharge flow rate and the actual pump flow rate.

Furthermore, in the pump system 1 according to the present embodiment, the received command discharge flow rate is corrected on the basis of the correction table, and the control device 18 calculates the command signal to be output, on the basis of the corrected command discharge flow rate and the pump characteristics. Therefore, it is possible to minimize the difference between the command discharge flow rate and the actual pump flow rate.

### Embodiment 2

### <Pump System>

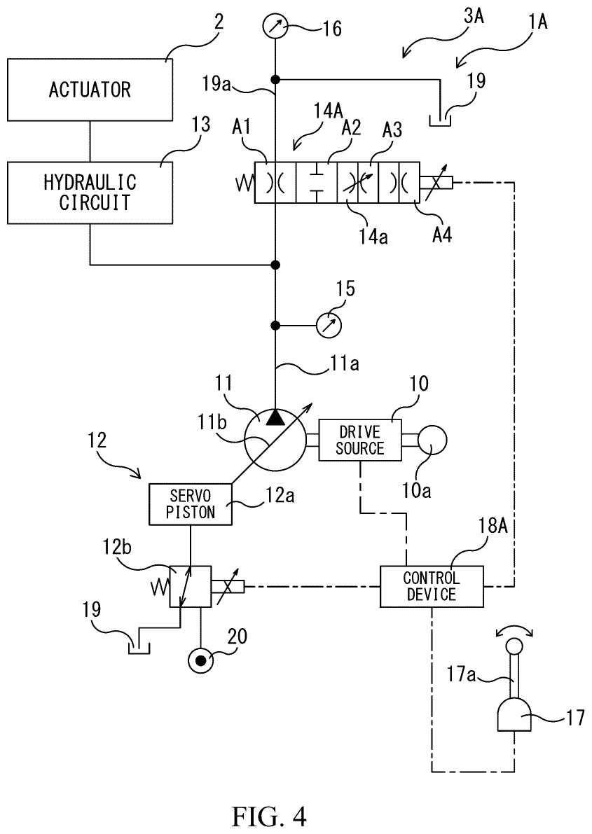

A pump system 1A according to Embodiment 2 includes elements similar to those of the pump system 1 according to Embodiment 1, as illustrated in FIG. 4. Therefore, the following description will focus on elements of the pump system 1A according to Embodiment 2 that are different from those of the pump system 1 according to Embodiment 1 while elements of the pump system 1A according to Embodiment 2 that are the same as those of the pump system 1 according to Embodiment 1 are assigned the same reference signs and description thereof will be omitted. Pump systems 1B, 1C according to Embodiments 3 to 4 will also be described later focusing on differences from the other embodiments, and elements thereof that are the same as those of the other embodiments will be assigned the same reference signs and description thereof will be omitted.

The pump system 1A according to Embodiment 2 is included in a hydraulic drive system 3A. The hydraulic drive system 3A includes at least one actuator 2, the hydraulic pump 11, the regulator 12, the hydraulic circuit 13, an unloader valve 14A, the two pressure sensors 15, 16, the operation device 17, and a control device 18A. The pump system 1A is configured to include at least the hydraulic pump 11, the regulator 12, the unloader valve 14A, the two pressure sensors 15, 16, and the control device 18A.

The unloader valve 14A, which is an example of the opening degree control valve, is a four-position spool valve. This means that the spool 14a moves to one of the first to fourth positions A1 to A4 according to a position signal that is input thereto. The spool 14a at the fourth position A4 fixes the opening degree of the unloader valve 14 at a second opening degree. In the present embodiment, the fourth position A4 is reached by further stroking the spool 14a from the third position A3. The second opening degree is set to an opening area greater than that of the first opening degree.

The control device 18A creates the correction table together with the hydraulic pump 11, the regulator 12, the unloader valve 14A, and the two pressure sensors 15, 16. Specifically, the control device 18A creates a correction table by performing the correction table creation method to be described in detail later.

### <Correction Table Creation Method>

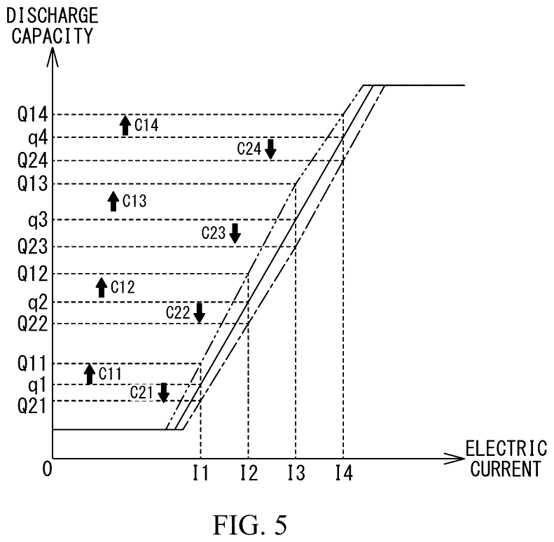

In the pump system 1A, the control device 18A performs the correction table creation method, and thus first and second correction tables are created. Note that the first correction table and the second correction table can be created in any order. First, creation of the first correction table will be described below. The control device 18A basically creates the first correction table in substantially the same method as the correction table creation method according to Embodiment 1 (refer to the corrected discharge flow rates Q11 to Q14 and the correction flow rates C11 to C14 in FIG. 5). Specifically, the control device 18A detects upstream pressure and downstream pressure for each of a plurality of command signals under a first measurement condition that is the aforementioned measurement condition, and creates the first correction table on the basis of the upstream pressure and the downstream pressure.

The correction table creation method performed by the control device 18A to create first pump characteristics differs in the following respects from the correction table creation method according to Embodiment 1. Specifically, the control device 18A sets a flow rate coefficient α according to the state of the opening degree of the unloader valve 14A in addition to an upstream-downstream pressure difference ΔP. More specifically, in the control device 18A, a flow rate coefficient table is stored that differs for each opening degree (in the present embodiment, for each of the first opening degree and the second opening degree) of the unloader valve 14. Furthermore, the control device 18A determines a flow rate coefficient α on the basis of a first flow rate coefficient table, which is a flow rate coefficient table for the first opening degree, and the upstream-downstream pressure difference ΔP of the unloader valve 14A. Subsequently, the control device 18A estimates the flow rate of the working fluid flowing through the unloader valve 14A (that is, the actual discharge flow rate at the hydraulic pump 11) on the basis of Equation (1) indicated above. Note that in Equation (1), A is an opening area when the opening degree of the unloader valve 14A is the first opening degree.

Next, creation of the second correction table will be described. With a plurality of command signals different from each other, the control device 18A causes the first pressure sensor 15 and the second pressure sensor 16 to detect the upstream pressure and the downstream pressure, respectively, under a second measurement condition. The second measurement condition includes the opening degree of the unloader valve 14A being fixed at the second opening degree. Therefore, the control device 18A moves the spool 14a to the fourth position A4 to maintain the opening degree of the unloader valve 14 at the second opening degree. In the present embodiment, the second measurement condition further includes the number of revolutions of the hydraulic pump 11 being the number of revolutions for calibration described above. Therefore, by controlling the drive source 10, the control device 18 adjusts the number of revolutions of the hydraulic pump 11 to the number of revolutions for calibration that corresponds to the command signal. Furthermore, the second measurement condition includes the control valves (not illustrated in the drawings) in the hydraulic circuit 13 being closed. Therefore, the control device 18A controls the control valves (not illustrated in the drawings) in the hydraulic circuit 13 in order to satisfy the measurement condition.

Next, the control device 18A calculates the upstream-downstream pressure difference of the unloader valve 14A on the basis of the upstream pressure and the downstream pressure detected under the second measurement condition. The control device 18A calculates the actual discharge flow rate at the hydraulic pump 11 for each command signal on the basis of the upstream-downstream pressure difference and the second opening degree of the unloader valve 14A. Subsequently, the control device 18 creates the second correction table on the basis of the command discharge flow rate and the actual discharge flow rate with respect to each command signal.

Hereinafter, the correction table creation method for the second pump characteristics will be described in more detail; similar to the correction table creation method for the first characteristics, the flow of the correction table creation method for the second pump characteristics is akin to that of the correction table creation method according to Embodiment 1. Therefore, the following description will focus on differences of the correction table creation method for the second pump characteristics from the correction table creation method according to Embodiment 1. In the pump system 1, in order that a plurality of command signals for calibration are output and the upstream pressure and the downstream pressure are detected under the second measurement condition, the control device 18A causes the spool 14a of the unloader valve 14A to move to the fourth position A4. As a result, the opening degree of the unloader valve 14A becomes the second opening degree. Furthermore, in estimating the actual discharge flow rate at the hydraulic pump 11 on the basis of Equation (1), the control device 18A determines the flow rate coefficient α on the basis of the flow rate coefficient table regarding the second opening degree and the upstream-downstream pressure difference of the unloader valve 14. In Equation (1), Q is the estimated flow rate of the working fluid flowing through the unloader valve 14A (that is, the estimated discharge flow rate at the hydraulic pump 11), A is an opening area when the opening degree of the unloader valve 14A is the second opening degree, and ΔP is the upstream-downstream pressure of the unloader valve 14A. Subsequently, the control device 18A calculates a corrected discharge flow rate on the basis of the actual discharge flow rate and calculates a correction flow rate on the basis of the command discharge flow rate and the corrected discharge flow rate (refer to the command discharge flow rates q1 to q4, the corrected discharge flow rates Q21 to Q24, and the correction flow rates C21 to C24 in FIG. 5). Thereafter, when correction flow rates are calculated and stored in association with all the command signals for calibration, the control device 18A creates the second correction table on the basis of the relationship between the command discharge flow rates and the correction flow rates stored.

Using the first and second correction tables, the control device 18A controls the regulator 12 as follows. Specifically, when the control device 18 receives an operation command from the operation device 17, the control device 18 calculates a command discharge flow rate on the basis of the operation command, as illustrated in FIG. 2. Furthermore, the control device 18A selects which one of the first and second correction tables is to be used in order to correct the command discharge flow rate. Subsequently, using the selected correction table, the control device 18A corrects the command discharge flow rate. For example, when the command discharge flow rate is lower than a predetermined flow rate, the control device 18A selects the first correction table. Subsequently, the control device 18A calculates a corrected flow rate on the basis of the command discharge flow rate and the first correction table. On the other hand, when the command discharge flow rate is higher than a predetermined flow rate, the control device 18A selects the second correction table. Subsequently, the control device 18A calculates a corrected flow rate on the basis of the command discharge flow rate and the second correction table. When the control device 18A calculates the corrected flow rate on the basis of the first or second correction table, the control device 18 corrects the command discharge flow rate on the basis of the correction flow rate. Furthermore, on the basis of the pump characteristics and the command discharge flow rate, the control device 18A calculates the command signal to be provided to the regulator 12. Thus, in the pump system 1, the working fluid can be discharged from the hydraulic pump 11 at a flow rate corresponding to the command discharge flow rate.

In the pump system 1A according to the present embodiment, the flow rate coefficient α is set in the control device 18A according to the state of the opening degree in addition to the upstream-downstream pressure difference. Therefore, the actual discharge flow rate can be calculated with increased accuracy. Thus, it is possible to further minimize the difference between the command discharge flow rate and the actual pump flow rate.

Furthermore, in the pump system 1A according to the present embodiment, the control device 18A holds the spool 14a at the fourth position in order to obtain the second correction table under the second measurement condition different from the first measurement condition. Therefore, the correction tables can be created at opening degrees different from each other. As a result, the actual discharge flow rate can be calculated with increased accuracy. Thus, it is possible to further minimize the difference between the command discharge flow rate and the actual pump flow rate.

The pump system 1A according to Embodiment 2 produces substantially the same advantageous effects as those produced by the pump system 1 according to Embodiment 1.

### Embodiment 3

### <Pump System>

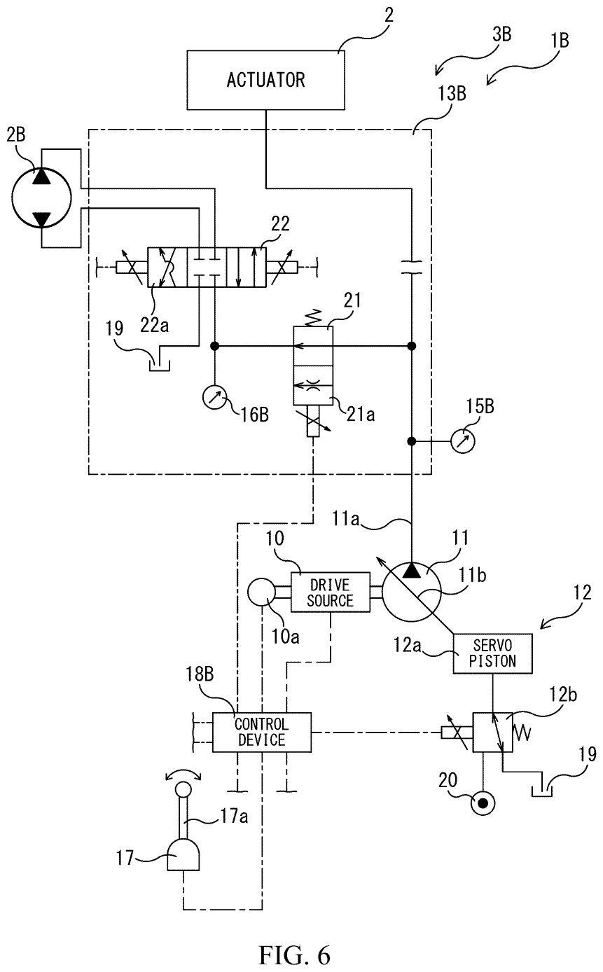

A pump system 1B according to Embodiment 3 is included in a hydraulic drive system 3B, as illustrated in FIG. 6. The hydraulic drive system 3B includes the actuator 2, the hydraulic pump 11, the regulator 12, a hydraulic circuit 13B, the unloader valve 14, a pressure sensor 15B, the operation device 17, and a control device 18B. In the present embodiment, the hydraulic drive system 3B includes a plurality of actuators 2, and the actuators 2 are connected to the hydraulic pump 11 in parallel. The plurality of actuators 2 include an actuator 2B. The actuator 2B is a hydraulic motor, for example; in the present embodiment, the actuator 2B is a traveling hydraulic motor 2B. The traveling hydraulic motor 2B drives a traveling device (for example, a crawler undercarriage and a tire) included in hydraulic equipment. The traveling hydraulic motor 2B is connected to the hydraulic pump 11 in parallel with other actuators 2. Specifically, the traveling hydraulic motor 2B is connected to the pump passage 11a in parallel with other actuators 2. The hydraulic circuit 13B is configured at least as follows in order to control the flow rate of the working fluid flowing to the traveling hydraulic motor 2B.

Specifically, the hydraulic circuit 13B includes at least a priority valve 21, a traveling control valve 22, and a traveling pressure sensor 16B. The priority valve 21, which is an example of the opening degree control valve, is connected to the pump passage 11a. The priority valve 21 is connected to the traveling hydraulic motor 2B via the traveling control valve 22. The priority valve 21 preferentially passes the working fluid to other actuators 2 over the traveling hydraulic motor 2B. More specifically, the priority valve 21 is an opening control valve and enables communication between the hydraulic pump 11 and the traveling hydraulic motor 2B, for example. The priority valve 21 causes a spool 21a to move to a throttle position corresponding to an opening degree signal that is input thereto. Thus, the passage between the hydraulic pump 11 and the traveling hydraulic motor 2B can be narrowed, and the narrowing allows the working fluid to be preferentially directed to other actuators 2.

The traveling control valve 22 is connected to the priority valve 21 and the traveling hydraulic motor 2B. The traveling control valve 22 moves the spool 22a according to a travel command signal that is input thereto. Thus, the traveling control valve 22 controls the flow (specifically, the direction of flow and the flow rate) of the working fluid to the traveling hydraulic motor 2B.

The traveling pressure sensor 16B, which is an example of the second pressure sensor, is provided on the downstream side of the priority valve 21. More specifically, the traveling pressure sensor 16B is connected between the priority valve 21 and the traveling control valve 22. The traveling pressure sensor 16B detects the hydraulic pressure on the downstream side of the priority valve 21, that is, the downstream pressure of the priority valve 21.

In the hydraulic drive system 3B configured as just described, the pump system 1B is configured as follows. Specifically, the pump system 1B is configured to include at least the hydraulic pump 11, the regulator 12, the priority valve 21, the two pressure sensors 15B, 16B, and the control device 18B. Note that the first pressure sensor 15B is connected to the pump passage 11a and measures, as the upstream pressure of the priority valve 21, the pressure of the working fluid flowing through the pump passage 11a. The first pressure sensor 15B does not necessarily need to be connected to the pump passage 11a; it is sufficient that the first pressure sensor 15B be able to detect the upstream pressure of the priority valve 21.

The control device 18B outputs the opening degree signal to the priority valve 21, thereby controlling the opening degree of the priority valve 21. By controlling the opening degree of the priority valve 21, the control device 18B controls the destination of the working fluid from the hydraulic pump 11 among the traveling hydraulic motor 2B and other actuators 2. Furthermore, the control device 18B outputs the travel command signal to the traveling control valve 22. Thus, the control device 18B controls the flow of the working fluid to the traveling hydraulic motor 2B.

The control device 18B having such functions creates the correction table together with the hydraulic pump 11, the regulator 12, the priority valve 21, and the two pressure sensors 15B, 16B. In other words, the control device 18B creates a correction table by performing the correction table creation method to be described in detail later.

### <Correction Table Creation Method>

In the pump system 1B, the control device 18B performs the correction table creation method, and thus the correction table is created. More specifically, the control device 18B performs the following detection under the measurement condition. Specifically, with a plurality of command signals different from each other, the control device 18B causes the first pressure sensor 15 and the traveling pressure sensor 16B to detect the upstream pressure and the downstream pressure of the priority valve 21, respectively. The measurement condition includes the opening degree of the priority valve 21 being fixed at a predetermined opening degree. In the present embodiment, the measurement condition further includes the number of revolutions of the hydraulic pump 11 being the number of revolutions for calibration that corresponds to the command signal. Therefore, by maintaining the priority valve 21 at the open position and controlling the drive source 10, the control device 18B adjusts the number of revolutions of the hydraulic pump 11 to the number of revolutions for calibration that corresponds to the command signal.

Next, the control device 18A calculates the upstream-downstream pressure difference of the priority valve 21 on the basis of the upstream pressure and the downstream pressure detected under the measurement condition. The control device 18B calculates the actual discharge flow rate at the hydraulic pump 11 for each command signal on the basis of the upstream-downstream pressure difference and the predetermined opening degree of the priority valve 21. Subsequently, the control device 18 creates the correction table on the basis of the command discharge flow rate and the actual discharge flow rate with respect to each command signal.

Hereinafter, the correction table creation method will be described in more detail; the flow of the correction table creation method is akin to that of the correction table creation method according to Embodiment 1. Therefore, the following description will focus on differences of the correction table creation method according to the present embodiment from the correction table creation method according to Embodiment 1. In the pump system 1B, the control device 18B holds the priority valve 21 at the open position, thereby fixing the opening degree of the priority valve 21 at the predetermined opening degree. In the present embodiment, the control device 18B places the priority valve 21 in a fully open state, for example. Furthermore, by controlling the drive source 10, the control device 18B adjusts the number of revolutions of the hydraulic pump 11 to the number of revolutions that corresponds to the command signal for calibration. Moreover, in the present embodiment, the measurement condition includes control valves (not illustrated in the drawings) in the hydraulic circuit 13B other than the traveling control valve 22 being closed and the traveling control valve 22 being fully open. As a result, the entire working fluid discharged from the hydraulic pump 11 flows through the priority valve 21. In order to pass the entire working fluid through the priority valve 21, the control device 18 controls control valves (not illustrated in the drawings) in the hydraulic circuit 13B.

When the measurement condition is satisfied, the control device 18B outputs one of the plurality of command signals for calibration to the regulator 12 under the measurement condition. The control device 18B then calculates the upstream-downstream pressure difference ΔP of the priority valve 21 on the basis of the upstream pressure and the downstream pressure detected by the two pressure sensors 15B, 16B. Furthermore, on the basis of the upstream-downstream pressure difference ΔP and the first opening degree of the priority valve 21, the control device 18B calculates the flow rate (that is, the actual discharge flow rate at the hydraulic pump 11) Q of the working fluid flowing through the priority valve 21. The control device 18B estimates the actual discharge flow rate at the hydraulic pump 11 on the basis of Equation (1) indicated above, for example. Note that the control device 18B, in which a flow rate coefficient table indicating the relationship between the upstream-downstream pressure difference ΔP of the priority valve 21 and the flow rate coefficient α is stored, determines a flow rate coefficient α on the basis of the upstream-downstream pressure difference ΔP and the flow rate coefficient table. Note that A is an opening area when the opening degree of the priority valve 21 is the predetermined opening degree.

Thereafter, the control device 18B calculates a corrected discharge flow rate by correcting the estimated actual discharge flow rate using the number of revolutions. Furthermore, the control device 18B calculates a command discharge flow rate on the basis of the command signal for calibration and the pump characteristics and calculates a correction flow rate on the basis of the command discharge flow rate and the corrected discharge flow rate. Moreover, the control device 18B stores the command discharge flow rate and the correction flow rate in association.

When correction flow rates are calculated and stored in association with all the command signals for calibration, the control device 18B creates a correction table on the basis of the relationship between the command discharge flow rates and the correction flow rates stored. Furthermore, similar to the control device 18 according to Embodiment 1, the control device 18B calculates a command signal on the basis of the command discharge flow rate corrected using the correction table, and outputs the command signal. Thus, the working fluid can be discharged from the hydraulic pump 11 at a flow rate corresponding to the command discharge flow rate.

In the pump system 1B according to the present embodiment, the pump characteristics can be calibrated using the priority valve 21 as with the unloader valves 14, 14A. Thus, in the pump system 1B including the priority valve 21, it is possible to minimize the difference between the command discharge flow rate and the actual pump flow rate.

The pump system 1B according to Embodiment 3 produces substantially the same advantageous effects as those produced by the pump system 1 according to Embodiment 1.

### Embodiment 4

### <Pump System>

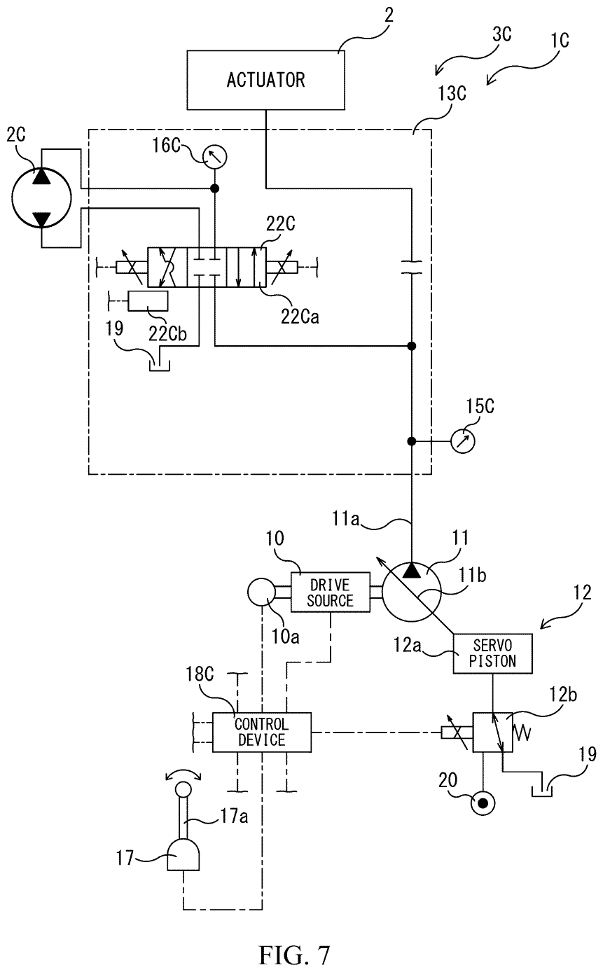

A pump system 1C according to Embodiment 4 is included in a hydraulic drive system 3C, as illustrated in FIG. 7. The hydraulic drive system 3C includes the actuator 2, the hydraulic pump 11, the regulator 12, a hydraulic circuit 13C, the unloader valve 14, a pressure sensor 15C, the operation device 17, and a control device 18C. In the present embodiment, the hydraulic drive system 3C includes a plurality of actuators 2, and the actuators 2 are connected to the hydraulic pump 11 in parallel. The plurality of actuators 2 include an actuator 2C. The actuator 2C is a hydraulic motor, for example; in the present embodiment, the actuator 2C is a slewing hydraulic motor 2C. The slewing hydraulic motor 2C slews a slewing body included in an excavator, a crane, or the like, for example. The slewing hydraulic motor 2C is connected to the hydraulic pump 11 in parallel with other actuators 2. Specifically, the slewing hydraulic motor 2C is connected to the pump passage 11a in parallel with other actuators 2. The hydraulic circuit 13C is configured at least as follows in order to control the flow rate of the working fluid flowing to the slewing hydraulic motor 2C.

Specifically, the hydraulic circuit 13C includes at least a slewing control valve 22C and a slewing pressure sensor 16C. The slewing control valve 22C, which is an example of the opening degree control valve, is connected to the pump passage 11a and the slewing hydraulic motor 2C. This means that the hydraulic pump 11 is connected to the slewing hydraulic motor 2C via the slewing control valve 22C. Furthermore, the slewing control valve 22C controls the flow of the working fluid flowing to the slewing hydraulic motor 2C. More specifically, the slewing control valve 22C moves a spool 22Ca according to the received slewing command signal. As a result, the connection between the slewing hydraulic motor 2C and the hydraulic pump 11 is switched. Thus, the direction of flow of the working fluid flowing to the slewing hydraulic motor 2C is controlled. Furthermore, the slewing control valve 22 serves as a flow rate control valve, meaning that it is possible to change the opening degree of the slewing control valve 22 by moving the spool 22Ca. Thus, the flow rate of the working fluid flowing to the slewing hydraulic motor 2C is controlled. Moreover, a position sensor 22Cb is provided on the slewing control valve 22C. The position sensor 22Cb, which is a stroke sensor, for example, detects the position (or the stroke length) of the spool 22Ca.

The slewing pressure sensor 16C, which is an example of the second pressure sensor, is provided on the downstream side of the slewing control valve 22C. More specifically, the slewing pressure sensor 16C is connected between one of the ports of the slewing hydraulic motor 2C and the slewing control valve 22C. The slewing pressure sensor 16C detects the hydraulic pressure on the downstream side of the slewing control valve 22C, that is, the downstream pressure of the slewing control valve 22C. Note that each of the slewing pressure sensors 16C may be connected between a corresponding one of the ports of the slewing hydraulic motor 2C and the slewing control valve 22C.

In the hydraulic drive system 3C configured as just described, the pump system 1C includes the following elements. Specifically, the pump system 1C is configured to include at least the hydraulic pump 11, the regulator 12, the slewing control valve 22C, the two pressure sensors 15C, 16C, and the control device 18C. Note that the first pressure sensor 15C is connected to the pump passage 11a. The first pressure sensor 15C measures the pressure of the working fluid flowing to the slewing control valve 22C, that is, the upstream pressure of the slewing control valve 22C. Note that the first pressure sensor 15C does not necessarily need to be connected to a passage connecting the pump passage 11a and the slewing control valve 22C; it is sufficient that the first pressure sensor 15C be able to detect the upstream pressure of the slewing control valve 22C.

The control device 18C outputs the slewing command signal to the slewing control valve 22C. Thus, the control device 18C controls the flow of the working fluid to the slewing hydraulic motor 2C. Furthermore, the control device 18C obtains the position of the spool 22Ca from the position sensor 22Cb.

Furthermore, the control device 18C can calibrate the pump characteristics together with the hydraulic pump 11, the regulator 12, the slewing control valve 22C, and the two pressure sensors 15C, 16C. Specifically, the control device 18C creates a correction table by performing the correction table creation method to be described in detail later.

### <Correction Table Creation Method>

In the pump system 1C, the control device 18C performs the correction table creation method, and thus a plurality of correction tables are created. More specifically, the control device 18C basically creates a plurality of pump characteristics by substantially the same method as the correction table creation method according to Embodiment 2. This means that the following detection is performed under a plurality of measurement conditions in which the slewing control valve 22C has different opening degrees. Specifically, with a plurality of command signals different from each other, the control device 18C causes the first pressure sensor 15C and the slewing pressure sensor 16C to detect the upstream pressure and the downstream pressure of the slewing control valve 22C. Note that each of the measurement conditions includes the number of revolutions of the hydraulic pump 11 being the number of revolutions for calibration that corresponds to the command signal. Therefore, the control device 18C outputs different slewing command signals to change the opening degree of slewing control valve 22C and controls the drive source 10 to adjust the number of revolutions of the hydraulic pump 11 to the number of revolutions for calibration that corresponds to the command signal.

Next, on the basis of the upstream pressure and downstream pressure detected under each of the measurement conditions, the control device 18C calculates the upstream-downstream pressure difference of the slewing control valve 22C. The control device 18C calculates the actual discharge flow rate at the hydraulic pump 11 for each command signal on the basis of the opening degree and the upstream-downstream pressure difference of the slewing control valve 22 under the measurement condition applied in the detection. Subsequently, the control device 18 creates a correction table on the basis of the command discharge flow rates and the actual discharge flow rates with respect to the command signals for each measurement condition, in other words, creates a correction table for each opening degree of the slewing control valve 22C.

Hereinafter, the correction table creation method will be described in more detail; the flow of the correction table creation method is akin to that of the correction table creation method according to Embodiment 1. Therefore, the following description will focus on differences of the correction table creation method according to the present embodiment from the correction table creation method according to Embodiment 1. In the pump system 1C, the control device 18C selects one measurement condition from among the plurality of measurement conditions, and further controls the opening degree of the slewing control valve 22C in order to satisfy the measurement condition that has been selected (hereinafter referred to as “the selected measurement condition”). At this time, by referring to the detection result of the position sensor 22Cb, the control device 18C maintains the opening degree of the slewing control valve 22C at an opening degree corresponding to the selected measurement condition. Furthermore, by controlling the drive source 10, the control device 18C adjusts the number of revolutions of the hydraulic pump 11 to the number of revolutions that corresponds to the command signal for calibration. Moreover, in the present embodiment, the control device 18C closes control valves (not illustrated in the drawings) in the hydraulic circuit 13C other than the slewing control valve 22C.

When the selected measurement condition is satisfied, the control device 18C outputs one of the plurality of command signals for calibration to the regulator 12 under the selected measurement condition. The control device 18C then calculates the upstream-downstream pressure difference ΔP of the slewing control valve 22C on the basis of the upstream pressure and the downstream pressure detected by the two pressure sensors 15C, 16C. Furthermore, on the basis of the upstream-downstream pressure difference ΔP and the opening degree of the slewing control valve 22C, the control device 18C calculates the flow rate (that is, the actual discharge flow rate at the hydraulic pump 11) Q of the working fluid flowing through the slewing control valve 22C. More specifically, the control device 18C estimates the actual discharge flow rate at the hydraulic pump 11 on the basis of Equation (1) indicated above, for example. Note that the control device 18C stores a flow rate coefficient table that is set for each opening degree of the slewing control valve 22C and indicates the relationship between the upstream-downstream pressure difference ΔP of the slewing control valve 22C and the flow rate coefficient α. The control device 18C determines a flow rate coefficient α on the basis of the slewing command signal, the upstream-downstream pressure difference ΔP, and the flow rate coefficient table.

Thereafter, the control device 18C calculates a corrected discharge flow rate by correcting the estimated actual discharge flow rate using the number of revolutions. Furthermore, the control device 18C calculates a command discharge flow rate on the basis of the command signal for calibration and the pump characteristics and calculates a correction flow rate on the basis of the command discharge flow rate and the corrected discharge flow rate. Subsequently, the control device 18C stores the command discharge flow rate and the corrected discharge flow rate in association. When correction flow rates are calculated and stored in association with all the command signals for calibration, the control device 18C creates a correction table on the basis of the relationship between the command discharge flow rates and the correction flow rates stored.

In substantially the same manner, the control device 18C detects the upstream pressure and the downstream pressure under each of the measurement conditions, and creates a correction table on the basis of the upstream pressure and the downstream pressure detected. When correction tables are created under all the measurement conditions, the correction table creation method ends. Thereafter, the control device 18C selects one of the plurality of correction tables according to the command discharge flow rate, and the command discharge flow rate is corrected using the selected correction table. Subsequently, on the basis of the corrected command discharge flow rate and the pump characteristics, the control device 18C calculates the command signal to be output to the regulator 12. Thus, in the pump system 1, the working fluid can be discharged from the hydraulic pump 11 at a flow rate corresponding to the command discharge flow rate.

In the pump system 1C according to the present embodiment, the pump characteristics can be calibrated using the slewing control valve 22C as with the unloader valves 14, 14A. Furthermore, in the pump system 1C including the slewing control valve 22C, it is possible to minimize the difference between the command discharge flow rate and the actual pump flow rate.

Furthermore, in the pump system 1C according to the present embodiment, the control device 18C creates a plurality of pump characteristics by calibrating the pump characteristics on the basis of the upstream pressure and the downstream pressure detected under the plurality of measurement conditions in which the slewing control valve 22C has different opening degrees. Therefore, the actual discharge flow rate can be calculated with increased accuracy. Thus, it is possible to minimize the difference between the command discharge flow rate and the actual pump flow rate.

The pump system 1C according to Embodiment 4 produces substantially the same advantageous effects as those produced by the pump system 1 according to Embodiment 1.

### Other Embodiments

The pump system 1 according to Embodiment 1 includes the second pressure sensor 16 connected between the unloader valve 14 and the tank 19, but does not necessarily need to include the second pressure sensor 16. In this case, in the pump system 1, the downstream pressure of the unloader valve 14 is set to predetermined tank pressure. This allows for a reduced number of components while producing substantially the same advantageous effects as those produced by the pump system 1. Note that the same is also true for the pump system 1A according to Embodiment 2.

In the pump systems 1, 1A to 1C according to Embodiments 1 to 4, the pump characteristics are created, but the pump characteristics do not necessarily need to be created. Furthermore, in the pump systems 1, 1A to 1C according to Embodiments 1 to 4, the regulator 12 includes the servo piston 12a and the electromagnetic proportional valve 12b, but this configuration is not limiting. For example, the servo piston 12a may be configured to be driven using a direct-acting motor or the like. In this case, the command signal is input to the direct-acting motor to change the discharge capacity. Furthermore, in the pump system 1C according to Embodiment 4, the slewing control valve 22C is in the form of a pilot-operated spool valve, but may be an electric spool valve in which a ball screw or the like moves the spool 22Ca accurately. In this case, the slewing control valve 22C does not need to include the position sensor 22Cb.

Furthermore, in the pump systems 1, 1A to 1D according to Embodiments 1 to 4, the unloader valves 14, 14A, the priority valve 21, and the slewing control valve 22C are exemplified as the opening degree control valve. However, the opening degree control valve is not limited to the above-described valves as long as the opening degree control valve has a variable opening degree. The flow rate coefficient α is set according to the state of the upstream-downstream pressure difference, but may be a fixed value. Furthermore, the flow rate coefficient α may be set according to the state of the outside temperature or the temperature of the working fluid in addition to the upstream-downstream pressure difference and the opening degree. Moreover, the measurement condition includes the number of revolutions of the hydraulic pump 11 being a predetermined number of revolutions for each signal, but the number of revolutions of the hydraulic pump 11 may be fixed. In addition, the positions at which the unloader valves 14, 14A are connected are not necessarily limited to the pump passage 11a; it is sufficient that the unloader valves 14, 14A be placed at locations such that the discharge pressure of the hydraulic pump 11 can be detected or estimated using the first pressure sensor 15.

### Exemplary Embodiments

A pump system according to the first aspect includes: a hydraulic pump of a variable capacity type having a discharge capacity that is changeable; a regulator that changes the discharge capacity of the hydraulic pump according to a command signal that is input to the regulator; an opening degree control valve connected to the hydraulic pump and having an opening degree that is changeable; a first pressure sensor that measures upstream pressure that is hydraulic pressure of a working fluid flowing from the hydraulic pump to the opening degree control valve; a second pressure sensor that measures downstream pressure that is hydraulic pressure of the working fluid flowing from the opening degree control valve; and a control device that controls the discharge capacity of the hydraulic pump according to pump characteristics indicating a relationship between a command discharge flow rate and the command signal. By changing the command signal to be output to the regulator, under a measurement condition in which the opening degree of the opening degree control valve is fixed at a predetermined opening degree, the control device causes the first pressure sensor and the second pressure sensor to detect the upstream pressure and the downstream pressure, respectively, with a plurality of command signals different from each other, calculates, for each command signal, an actual discharge flow rate of the working fluid discharged from the hydraulic pump, on the basis of the opening degree of the opening degree control valve and a pressure difference between pressure on an upstream side of the opening degree control valve and pressure on a downstream side of the opening degree control valve that is calculated on the basis of the upstream pressure and the downstream pressure detected, and creates a correction table for correcting the command discharge flow rate on the basis of the command discharge flow rate and the actual discharge flow rate with respect to each command signal.

According to this aspect, the actual discharge flow rate is calculated for each command signal on the basis of the pressure difference and the opening degree of the opening degree control valve. Subsequently, the correction table is created on the basis of the command discharge flow rate and the actual discharge flow rate with respect to each command signal. Therefore, the control device outputs the command signal according to the command discharge flow rate corrected using the correction table, thereby allowing the working fluid to be actually discharged from the hydraulic pump at a flow rate corresponding to the command discharge flow rate. Thus, it is possible to minimize the difference between the command discharge flow rate and the actual pump flow rate.

A pump system according to the second aspect is the pump system according to the first aspect in which the control device uses a flow rate coefficient in calculating the actual discharge flow rate on the basis of the pressure difference and the opening degree, and the flow rate coefficient is set in the control device according to a state of the pressure difference.

According to this aspect, the flow rate coefficient is set in the control device according to the state of the pressure difference. Therefore, the actual discharge flow rate can be calculated with increased accuracy. Thus, it is possible to further minimize the difference between the command discharge flow rate and the actual pump flow rate.

A pump system according to the third aspect is the pump system according to the first or second aspect in which the control device uses a flow rate coefficient in calculating the actual discharge flow rate on the basis of the pressure difference and the opening degree, and the flow rate coefficient is set in the control device according to a state of the opening degree.

According to this aspect, the flow rate coefficient is set in the control device according to the state of the opening degree in addition to the upstream-downstream pressure difference. Therefore, the actual discharge flow rate can be calculated with increased accuracy. Thus, it is possible to further minimize the difference between the command discharge flow rate and the actual pump flow rate.

A pump system according to the fourth aspect is the pump system according to any one of the first to third aspects in which the control device creates, on the basis of a difference between the command discharge flow rate and the actual discharge flow rate with respect to each command signal, the correction table for correcting the command discharge flow rate.

According to this aspect, the correction table is created on the basis of the difference between the command discharge flow rate and the actual discharge flow rate with respect to each command signal. Therefore, it is possible to further minimize the difference between the command discharge flow rate and the actual pump flow rate.

A pump system according to the fifth aspect is the pump system according to any one of the first to fourth aspects in which the measurement condition includes a number of revolutions of the hydraulic pump being a number of revolutions that is set in advance for each command signal.

According to this aspect, the measurement condition includes the number of revolutions of the hydraulic pump being the number of revolutions that is predetermined for each command signal. By maintaining the number of revolutions at a predetermined number of revolutions, the flow rate of the working fluid discharged from the hydraulic pump can be prevented from varying due to fluctuations in the number of revolutions. As a result, variations in the discharge pressure at the hydraulic pump can be reduced and thus, the actual discharge flow rate can be calculated with high accuracy. Therefore, the actual discharge flow rate can be calculated with increased accuracy. Thus, it is possible to further minimize the difference between the command discharge flow rate and the actual pump flow rate.

A pump system according to the sixth aspect is the pump system according to any one of the first to fifth aspects in which the opening degree control valve includes a valve body that is movable to a first position at which the valve body fixes the opening degree at the predetermined opening degree, a second position at which the valve body blocks a path between the hydraulic pump and a tank, and a third position at which the valve body changes the opening degree according to a stroke length, and the control device holds the valve body at the first position in order to obtain a first correction table under a first measurement condition.

According to this aspect, the control device holds the valve body of the opening degree control valve at the first position at which the valve body fixes the opening degree at the predetermined opening degree in order to satisfy the first measurement condition. Therefore, the opening degree of the opening degree control valve can be easily maintained at the predetermined opening degree. As a result, the actual discharge flow rate can be calculated with increased accuracy. Thus, it is possible to further minimize the difference between the command discharge flow rate and the actual pump flow rate.

A pump system according to the seventh aspect is the pump system according to the sixth aspect in which the valve body is movable to a fourth position at which the valve body fixes the opening degree at a second opening degree greater than a first opening degree that is the predetermined opening degree, and the control device holds the valve body at the fourth position in order to obtain a second correction table under a second measurement condition.

According to this aspect, the control device holds the valve body at the fourth position in order to obtain the second correction table under the second measurement condition different from the first measurement condition. Therefore, it is possible to create the correction tables at opening degrees different from each other. As a result, the actual discharge flow rate can be calculated with increased accuracy. Thus, it is possible to further minimize the difference between the command discharge flow rate and the actual pump flow rate.

A pump system according to the eighth aspect is the pump system according to any one of the first to fifth aspects in which the opening degree control valve is an unloader valve, the hydraulic pump is connected via a pump passage to a hydraulic circuit to which the hydraulic pump supplies the working fluid, and the unloader valve is connected to the pump passage on an upstream side of the hydraulic circuit.

According to this aspect, the opening degree control valve is an unloader valve, and the unloader valve is connected to the pump passage on the upstream side of the hydraulic circuit. Therefore, pressure loss that occurs in the working fluid flowing from the hydraulic pump to the unloader valve has less impact, enabling accurate calculation of the upstream-downstream pressure difference of the unloader valve. As a result, the actual discharge flow rate can be calculated with increased accuracy. Thus, it is possible to further minimize the difference between the command discharge flow rate and the actual pump flow rate.

A pump system according to the ninth aspect is the pump system according to any one of the first to fifth aspects in which the opening degree control valve is a priority valve, the hydraulic pump is connected to a plurality of actuators, and the priority valve preferentially passes the working fluid to one of the plurality of actuators.

According to this aspect, the opening degree control valve is a priority valve. Using the pressure difference of the priority valve, the pump characteristics can be calibrated. Thus, in the pump system including the priority valve, it is possible to minimize the difference between the command discharge flow rate and the actual pump flow rate.

A pump system according to the tenth aspect is the pump system according to any one of the first to fifth aspects in which the opening degree control valve is a flow rate control valve, the hydraulic pump is connected to an actuator via the flow rate control valve, and the flow rate control valve controls a flow of the working fluid flowing to the actuator.

According to this aspect, the opening degree control valve is a flow rate control valve. Using the pressure difference of the flow rate control valve, the pump characteristics can be calibrated. Thus, in the pump system including the flow rate control valve, it is possible to minimize the difference between the command discharge flow rate and the actual pump flow rate.

A pump system according to the eleventh aspect is the pump system according to any one of the first to tenth aspects in which the control device corrects, on the basis of the correction table created, the command discharge flow rate that is input to the control device, and calculates, on the basis of the command discharge flow rate corrected and the pump characteristics, the command signal to be output.

According to this aspect, the received command discharge flow rate is corrected on the basis of the correction table, and the control device calculates the command signal to be output, on the basis of the corrected command discharge flow rate and the pump characteristics. Therefore, it is possible to minimize the difference between the command discharge flow rate and the actual pump flow rate.

A pump system according to the twelfth aspect includes: a hydraulic pump of a variable capacity type having a discharge capacity that is changeable; a regulator that changes the discharge capacity of the hydraulic pump according to a command signal that is input to the regulator; an unloader valve disposed between the hydraulic pump and a tank and having an opening degree that is changeable; a first pressure sensor that measures hydraulic pressure of a working fluid flowing from the hydraulic pump to the unloader valve; and a control device that controls the discharge capacity of the hydraulic pump according to pump characteristics indicating a relationship between a command discharge flow rate and the command signal. By changing the command signal to be output to the regulator, under a measurement condition in which the opening degree of the unloader valve is fixed at a predetermined opening degree, the control device causes the first pressure sensor to detect the hydraulic pressure, with a plurality of command signals different from each other, calculates, for each command signal, an actual discharge flow rate of the working fluid discharged from the hydraulic pump, on the basis of the opening degree of the unloader valve and a pressure difference between pressure on an upstream side of the unloader valve and pressure on a downstream side of the unloader valve that is calculated on the basis of the hydraulic pressure detected, and creates a correction table for correcting the command discharge flow rate on the basis of the command discharge flow rate and the actual discharge flow rate with respect to each command signal.

According to this aspect, the actual discharge flow rate is calculated for each command signal on the basis of the pressure difference and the opening degree of the unloader valve. Subsequently, the correction table is created on the basis of the command discharge flow rate and the actual discharge flow rate with respect to each signal value. Therefore, the control device allows the working fluid to be actually discharged from the hydraulic pump at a flow rate corresponding to the command discharge flow rate. Thus, it is possible to minimize the difference between the command discharge flow rate and the actual pump flow rate.

From the foregoing description, many modifications and other embodiments of the present disclosure would be obvious to a person having ordinary skill in the art. Therefore, the foregoing description should be interpreted only as an example and is provided for the purpose of teaching the best mode for carrying out the present disclosure to a person having ordinary skill in the art. Substantial changes in details of the structures and/or functions of the present disclosure are possible within the spirit of the present disclosure.

1. A pump system comprising:
a hydraulic pump of a variable capacity type having a discharge capacity that is changeable;
a regulator that changes the discharge capacity of the hydraulic pump according to a command signal that is input to the regulator;
an opening degree control valve connected to the hydraulic pump and having an opening degree that is changeable;
a first pressure sensor that measures upstream pressure that is hydraulic pressure of a working fluid flowing from the hydraulic pump to the opening degree control valve;
a second pressure sensor that measures downstream pressure that is hydraulic pressure of the working fluid flowing from the opening degree control valve; and
a control device that controls the discharge capacity of the hydraulic pump according to pump characteristics indicating a relationship between a command discharge flow rate and the command signal, wherein:
by changing the command signal to be output to the regulator, under a measurement condition in which the opening degree of the opening degree control valve is fixed at a predetermined opening degree, the control device causes the first pressure sensor and the second pressure sensor to detect the upstream pressure and the downstream pressure, respectively, with a plurality of command signals different from each other, calculates, for each command signal, an actual discharge flow rate of the working fluid discharged from the hydraulic pump, on the basis of the opening degree of the opening degree control valve and a pressure difference between pressure on an upstream side of the opening degree control valve and pressure on a downstream side of the opening degree control valve that is calculated on the basis of the upstream pressure and the downstream pressure detected, and creates a correction table for correcting the command discharge flow rate on the basis of the command discharge flow rate and the actual discharge flow rate with respect to each command signal.

2. The pump system according to claim 1, wherein:
the control device uses a flow rate coefficient in calculating the actual discharge flow rate on the basis of the pressure difference and the opening degree; and
the flow rate coefficient is set in the control device according to a state of the pressure difference.

3. The pump system according to claim 1, wherein:
the control device uses a flow rate coefficient in calculating the actual discharge flow rate on the basis of the pressure difference and the opening degree; and
the flow rate coefficient is set in the control device according to a state of the opening degree.

4. The pump system according to claim 1, wherein:
the control device creates, on the basis of a difference between the command discharge flow rate and the actual discharge flow rate with respect to each command signal, the correction table for correcting the command discharge flow rate.

5. The pump system according to claim 1, wherein:
the measurement condition includes a number of revolutions of the hydraulic pump being a number of revolutions that is set in advance for each command signal.

6. The pump system according to claim 1, wherein:
the opening degree control valve includes a valve body that is movable to a first position at which the valve body fixes the opening degree at the predetermined opening degree, a second position at which the valve body blocks a path between the hydraulic pump and a tank, and a third position at which the valve body changes the opening degree according to a stroke length; and
the control device holds the valve body at the first position in order to obtain a first correction table under a first measurement condition.

7. The pump system according to claim 6, wherein:
the valve body is movable to a fourth position at which the valve body fixes the opening degree at a second opening degree greater than a first opening degree that is the predetermined opening degree; and
the control device holds the valve body at the fourth position in order to obtain a second correction table under a second measurement condition.

8. The pump system according to claim 1, wherein:
the opening degree control valve is an unloader valve;
the hydraulic pump is connected via a pump passage to a hydraulic circuit to which the hydraulic pump supplies the working fluid; and
the unloader valve is connected to the pump passage on an upstream side of the hydraulic circuit.

9. The pump system according to claim 1, wherein:
the opening degree control valve is a priority valve;
the hydraulic pump is connected to a plurality of actuators; and
the priority valve preferentially passes the working fluid to one of the plurality of actuators.

10. The pump system according to claim 1, wherein:
the opening degree control valve is a flow rate control valve;
the hydraulic pump is connected to an actuator via the flow rate control valve; and
the flow rate control valve controls a flow of the working fluid flowing to the actuator.

11. The pump system according to claim 1, wherein:
the control device corrects, on the basis of the correction table created, the command discharge flow rate that is input to the control device, and calculates, on the basis of the command discharge flow rate corrected and the pump characteristics, the command signal to be output.

12. A pump system comprising:
a hydraulic pump of a variable capacity type having a discharge capacity that is changeable;
a regulator that changes the discharge capacity of the hydraulic pump according to a command signal that is input to the regulator;
an unloader valve disposed between the hydraulic pump and a tank and having an opening degree that is changeable;
a first pressure sensor that measures hydraulic pressure of a working fluid flowing from the hydraulic pump to the unloader valve; and
a control device that controls the discharge capacity of the hydraulic pump according to pump characteristics indicating a relationship between a command discharge flow rate and the command signal, wherein:
by changing the command signal to be output to the regulator, under a measurement condition in which the opening degree of the unloader valve is fixed at a predetermined opening degree, the control device causes the first pressure sensor to detect the hydraulic pressure, with a plurality of command signals different from each other, calculates, for each command signal, an actual discharge flow rate of the working fluid discharged from the hydraulic pump, on the basis of the opening degree of the unloader valve and a pressure difference between pressure on an upstream side of the unloader valve and pressure on a downstream side of the unloader valve that is calculated on the basis of the hydraulic pressure detected, and creates a correction table for correcting the command discharge flow rate on the basis of the command discharge flow rate and the actual discharge flow rate with respect to each command signal.
